(19) United States
(12) Patent Application Publication
(10) Pub. No.: US 2026/0275619 A1
(43) Pub. Date: Sep. 17, 2026

(54) DOOR ASSEMBLY FOR A LAUNDRY APPLIANCE

(71) Applicant: Haier US Appliance Solutions, Inc., Wilmington, DE (US)

(72) Inventors: Jordan Kyle Weidner, Louisville, KY (US); Christopher Gene Vowels, Cox's Creek, KY (US); Venkata Chakradhar Rangu, Louisville, KY (US); José Luis Morales Chimal, Querétaro (MX)

(21) Appl. No.: 19/080,476

(22) Filed: Mar. 14, 2025

(51) Int. Cl. D06F 39/14; D06F 23/02; D06F 58/02; D06F 58/20; E05D 11/00

(52) U.S. Cl. CPC D06F 39/14; D06F 23/02; D06F 58/02; D06F 58/20; E05D 11/0009; E05Y 2900/312

(57) ABSTRACT

A door assembly for a laundry appliance includes an outer door frame, a first locator pin and a second locator pin extending from the outer door frame, wherein each of the first locator pin and the second locator pin define a first portion having a first width and a second portion having a second width smaller than the first width, the second portion being positioned on top of the first portion opposite the outer door frame, a bracket mounted to the outer door frame, and a first aperture and a second aperture defined on the bracket opposite from the first locator pin and the second locator pin, wherein the first aperture is configured to receive the first locator pin and the second aperture is elongated along the vertical direction and configured to receive the second locator pin.

### FIELD OF THE INVENTION

The present subject matter relates generally to laundry appliances, or more specifically, to door assemblies of laundry appliances.

### BACKGROUND OF THE INVENTION

Washing machine appliances generally include a tub for containing water or wash fluid, e.g., water and detergent, bleach, and/or other wash additives. A basket is rotatably mounted within the tub and defines a wash chamber for receipt of articles for washing. During normal operation of such washing machine appliances, the wash fluid is directed into the tub and onto articles within the wash chamber of the basket. The basket or an agitation element can rotate at various speeds to agitate articles within the wash chamber, to wring wash fluid from articles within the wash chamber, etc. During a spin or drain cycle, a drain pump assembly may operate to discharge water from within sump.

Notably, conventional outer door frames do not include component locators that can receive a non-reversible door hinge bracket or reinforcement brackets for a reversible door hinge bracket, necessitating the use of outer door frames having different designs, tooling, costs, and decreased flexibility. Conventional outer door frames also experience issues with accounting for door sag for a washer or dryer, specifically related to the striker alignment of the door. There are multiple components of a laundry appliance door that contribute to striker alignment of the appliance door when it is opened and closed, including the reinforcement brackets. Improperly constraining the degrees of freedom of the reinforcement brackets with insufficient locating features and/or fasteners adds more variation to the assembly and the striker alignment, as well as making assembly more difficult.

Accordingly, a laundry appliance having an improved door would be desirable. More specifically, an appliance door that is easy to assemble while providing improved rigidity and alignment between the striker and associated latch would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a laundry appliance defining a vertical direction, a lateral direction, and a transverse direction is provided, including a tub positioned within a cabinet, a basket rotatably mounted within the tub and defining a chamber for receiving of a load of clothes, and a door assembly rotatably mounted to the cabinet to provide selective access to the chamber. The door assembly includes an outer door frame defining a first face and a second face positioned opposite the first face along the transverse direction, a first locator pin and a second locator pin extending from the second face of the outer door frame, wherein each of the first locator pin and the second locator pin define a first portion having a first width and a second portion having a second width smaller than the first width, the second portion being positioned on top of the first portion opposite the outer door frame, a bracket defining a first face and a second face positioned opposite the first face along the transverse direction, the bracket being mounted to the second face of the outer door frame, and a first aperture and a second aperture defined on the first face of the bracket opposite from the first locator pin and the second locator pin, wherein the first aperture is configured to receive the first locator pin and the second aperture is elongated along the vertical direction and configured to receive the second locator pin

In another exemplary embodiment, a door assembly for a laundry appliance is provided. The laundry appliance defines a vertical direction, a lateral direction, and a transverse direction and includes a tub positioned within a cabinet and a basket rotatably mounted within the tub and defining a chamber for receiving of a load of clothes. The door assembly includes an outer door frame defining a first face and a second face positioned opposite the first face along the transverse direction, a first locator pin and a second locator pin extending from the second face of the outer door frame, wherein each of the first locator pin and the second locator pin define a first portion having a first width and a second portion having a second width smaller than the first width, the second portion being positioned on top of the first portion opposite the outer door frame, a bracket defining a first face and a second face positioned opposite the first face along the transverse direction, the bracket being mounted to the second face of the outer door frame, and a first aperture and a second aperture defined on the first face of the bracket opposite from the first locator pin and the second locator pin, wherein the first aperture is configured to receive the first locator pin and the second aperture is elongated along the vertical direction and configured to receive the second locator pin.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a washing machine appliance according to an example embodiment of the present subject matter.

FIG. 2 provides a front view of the example washing machine appliance of FIG. 1 with a door assembly in the open position according to an example embodiment of the present subject matter.

FIG. 3 provides a side cross-sectional view of the example washing machine appliance of FIG. 1 according to an example embodiment of the present subject matter.

FIG. 4 provides an exploded view of the example door assembly of FIG. 2 according to an example embodiment of the present subject matter.

FIG. 5 provides a rear view of the example door assembly of FIG. 2 according to an example embodiment of the present subject matter.

FIG. 6 provides an exploded rear view of the example door assembly of FIG. 2 according to an example embodiment of the present subject matter.

FIG. 7 provides a perspective view of a locator pin of the example door assembly of FIG. 2 according to an example embodiment of the present subject matter.

FIG. 8 provides a rear view of the example locator pin of FIG. 7 received within an aperture of a reinforcement bracket of the example door assembly of FIG. 2 according to an example embodiment of the present subject matter.

FIG. 9 provides a rear view of the example locator pin of FIG. 7 received within another aperture of a reinforcement bracket of the example door assembly of FIG. 2 according to an example embodiment of the present subject matter.

FIG. 10 provides a cross-sectional view of the example locator pin of FIG. 7 received within an aperture of a reinforcement bracket of the example door assembly of FIG. 2 according to an example embodiment of the present subject matter.

FIG. 11 provides an exploded rear view of the example door assembly of FIG. 2 according to another example embodiment of the present subject matter.

FIG. 12 provides an exploded rear view of the example door assembly of FIG. 11 according to an example embodiment of the present subject matter.

FIG. 13 provides a cross-sectional view of a locator pin received within an aperture of a hinge bracket of the example door assembly of FIG. 2 according to an example embodiment of the present subject matter.

FIG. 14 provides a cross-sectional view of a locator pin received within another aperture of a hinge bracket of the example door assembly of FIG. 2 according to an example embodiment of the present subject matter.

FIG. 15 provides a rear view of a first aperture of a hinge bracket according to an example embodiment of the present subject matter.

FIG. 16 provides a rear view of a second aperture of the example hinge bracket of FIG. 15 according to an example embodiment of the present subject matter.

FIG. 17 provides a rear view of a third aperture of the example hinge bracket of FIG. 15 according to an example embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a 10 percent margin.

As explained herein, aspects of the present subject matter are generally directed to a system and method of locating and mating three/four parts together in a laundry appliance door, allowing for easy assembly. Two locator pins on the laundry appliance outer door frame may protrude through one locator hole at the top and a vertical aperture at the bottom. These features are capable of locating a non-reversible door hinge and a door reinforcement bracket, which has a reversible door hinge assembled to the bracket. Each locator pin may be designed with two different diameters at two different lengths, where the larger diameter pin locates a non-reversible hinge bracket while the smaller diameter pin locates the reinforcement bracket for a reversible door. The screw bosses on the outer door frame may contact the backside surface of the non-reversible hinge bracket or reinforcement bracket to constrain three degrees of freedom of either bracket. For example, these features may constrain one degree in translation and two degrees in rotations, e.g., such as translation in Z, and rotation about Y and X. These locator pins on the outer door frame may allow for the laundry appliance door to be capable of being reversible or non-reversible while also locating the hinge bracket/reinforcement bracket properly in the assembly, which contributes to improved door striker position.

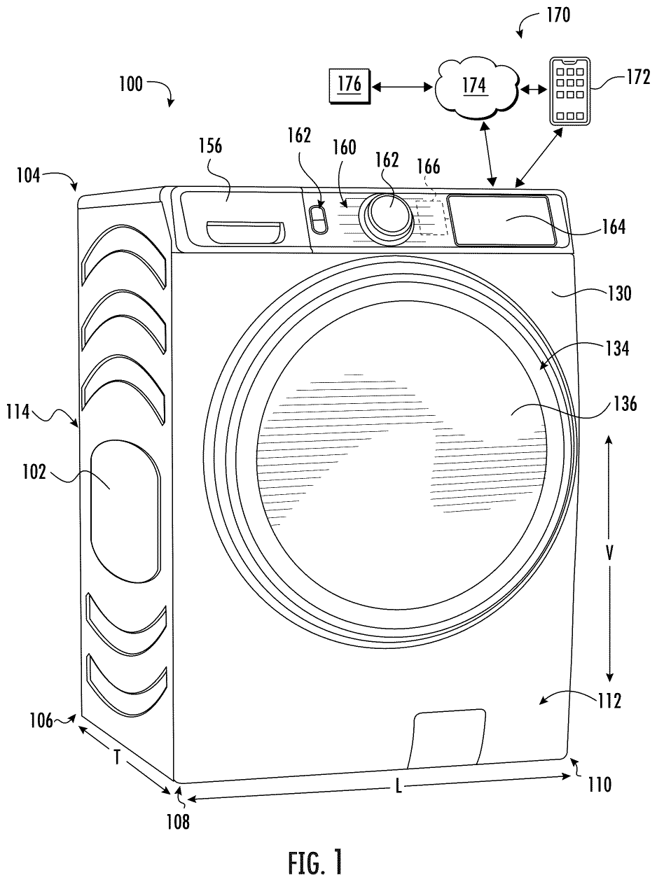

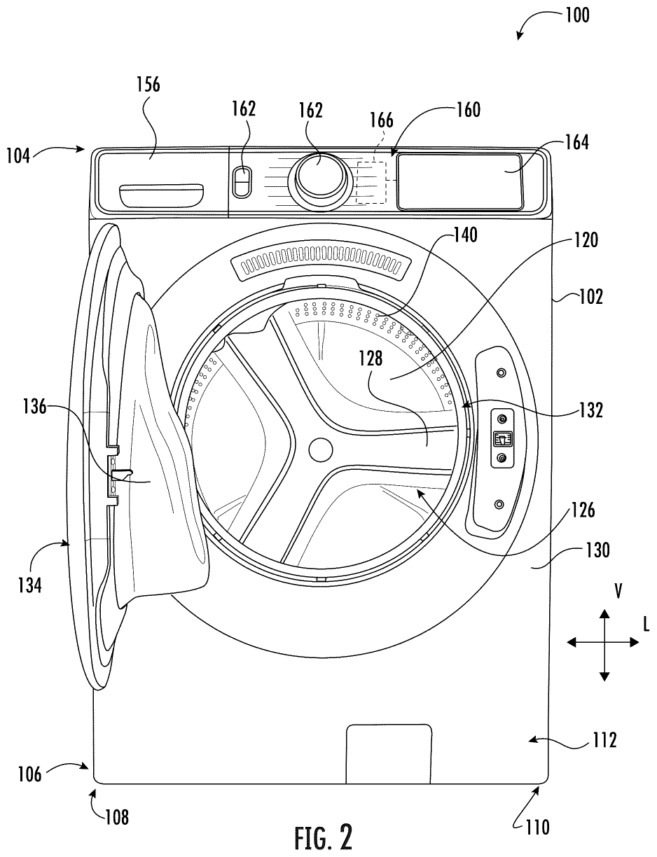

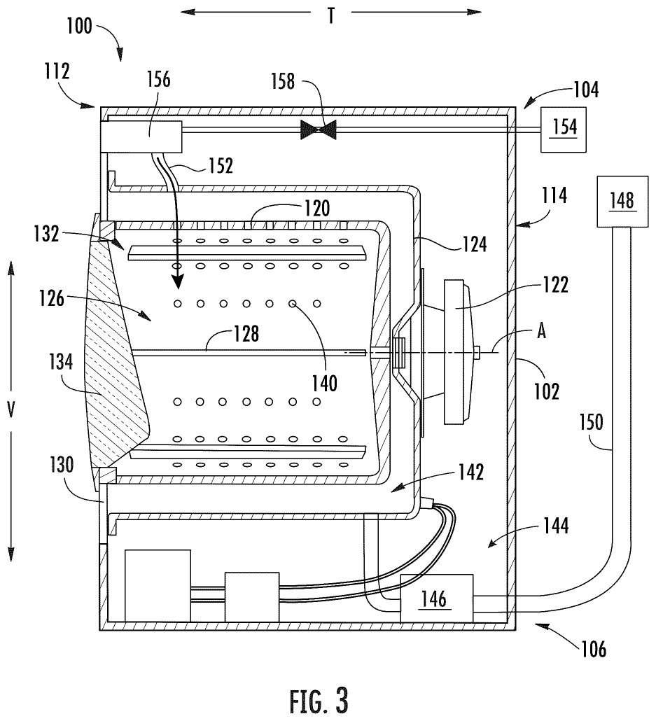

Referring now to the figures, FIG. 1 is a perspective view of an exemplary horizontal axis washing machine appliance 100, FIG. 2 is a front view of washing machine appliance 100, and FIG. 3 is a side cross-sectional view of washing machine appliance 100. As illustrated, washing machine appliance 100 generally defines a vertical direction V, a lateral direction L, and a transverse direction T, each of which is mutually perpendicular, such that an orthogonal coordinate system is generally defined. Washing machine appliance 100 includes a cabinet 102 that extends between a top 104 and a bottom 106 along the vertical direction V, between a left side 108 and a right side 110 along the lateral direction, and between a front 112 and a rear 114 along the transverse direction T.

Referring to FIGS. 2 and 3, a wash basket 120 is rotatably mounted within cabinet 102 such that it is rotatable about an axis of rotation A. A motor 122, e.g., such as a pancake motor, is in mechanical communication with wash basket 120 to selectively rotate wash basket 120 (e.g., during an agitation or a rinse cycle of washing machine appliance 100). Wash basket 120 is received within a wash tub 124 and defines a wash chamber 126 that is configured for receipt of articles for washing. The wash tub 124 holds wash and rinse fluids for agitation in wash basket 120 within wash tub 124. As used herein, “wash fluid” may refer to water, detergent, fabric softener, bleach, or any other suitable wash additive or combination thereof. Indeed, for simplicity of discussion, these terms may all be used interchangeably herein without limiting the present subject matter to any particular “wash fluid.”

Wash basket 120 may define one or more agitator features that extend into wash chamber 126 to assist in agitation and cleaning articles disposed within wash chamber 126 during operation of washing machine appliance 100. For example, as illustrated in FIG. 3, a plurality of ribs 128 extends from basket 120 into wash chamber 126. In this manner, for example, ribs 128 may lift articles disposed in wash basket 120 during rotation of wash basket 120.

Referring generally to FIGS. 1 through 3, cabinet 102 also includes a front panel 130 which defines a chamber opening 132 that permits user access to wash basket 120 of wash tub 124. More specifically, washing machine appliance 100 includes a door 134 that is positioned over chamber opening 132 and is rotatably mounted to front panel 130. In this manner, door 134 permits selective access to chamber opening 132 by being movable between an open position (FIG. 2) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 100. Door 134 also includes a handle (not labeled) that, e.g., a user may pull when opening and closing door 134. Further, although door 134 is illustrated as mounted to front panel 130, it should be appreciated that door 134 may be mounted to another side of cabinet 102 or any other suitable support according to alternative embodiments.

Referring again to FIG. 3, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 100. For example, during operation of washing machine appliance 100, wash fluid may be urged by gravity from basket 120 to sump 142 through plurality of perforations 140.

A drain pump assembly 144 is located beneath wash tub 124 and is in fluid communication with sump 142 for periodically discharging soiled wash fluid from washing machine appliance 100. Drain pump assembly 144 may generally include a drain pump 146 which is in fluid communication with sump 142 and with an external drain 148 through a drain hose 150. During a drain cycle, drain pump 146 urges a flow of wash fluid from sump 142, through drain hose 150, and to external drain 148. More specifically, drain pump 146 includes a motor (not shown) which is energized during a drain cycle such that drain pump 146 draws wash fluid from sump 142 and urges it through drain hose 150 to external drain 148.

A spout (such as supply conduit 152) may be configured for directing a flow of fluid into wash tub 124. For example, supply conduit 152 may be in fluid communication with a water supply 154 (FIG. 3) in order to direct fluid (e.g., clean water or wash fluid) into wash tub 124. Supply conduit 152 may also be in fluid communication with the sump 142. For example, pump assembly 144 may direct wash fluid disposed in sump 142 to supply conduit 152 in order to circulate wash fluid in wash tub 124.

As illustrated in FIG. 3, a detergent drawer 156 is slidably mounted within front panel 130. Detergent drawer 156 receives a wash additive (e.g., detergent, fabric softener, bleach, or any other suitable liquid or powder) and directs the fluid additive to wash tub 124 during operation of washing machine appliance 100. According to the illustrated embodiment, detergent drawer 156 may also be fluidly coupled to supply conduit 152 to facilitate the complete and accurate dispensing of wash additive.

In addition, a water supply valve 158 may provide a flow of water from a water supply source (such as a municipal water supply 154) into detergent dispenser 156 and into wash tub 124. In this manner, water supply valve 158 may generally be operable to supply water into detergent dispenser 156 to generate a wash fluid, e.g., for use in a wash cycle, or a flow of fresh water, e.g., for a rinse cycle. It should be appreciated that water supply valve 158 may be positioned at any other suitable location within cabinet 102. In addition, although water supply valve 158 is described herein as regulating the flow of “wash fluid,” it should be appreciated that this term includes, water, detergent, other additives, or some mixture thereof.

A control panel 160 including a plurality of input selectors 162 is coupled to front panel 130. Control panel 160 and input selectors 162 collectively form a user interface input for operator selection of machine cycles and features. For example, in one embodiment, a display 164 indicates selected features, a countdown timer, and/or other items of interest to machine users.

Operation of washing machine appliance 100 is controlled by a controller or processing device 166 (FIG. 1) that is operatively coupled to control panel 160 for user manipulation to select washing machine cycles and features. In response to user manipulation of control panel 160, controller 166 operates the various components of washing machine appliance 100 to execute selected machine cycles and features.

Controller 166 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 166 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Control panel 160 and other components of washing machine appliance 100 may be in communication with controller 166 via one or more signal lines or shared communication busses.

During operation of washing machine appliance 100, laundry items are loaded into wash basket 120 through chamber opening 132, and washing operation is initiated through operator manipulation of input selectors 162. Wash tub 124 is filled with water, detergent, and/or other fluid additives, e.g., via supply conduit 152 and or detergent drawer 156. One or more valves (e.g., water supply valve 158) can be controlled by washing machine appliance 100 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with ribs 128) for washing of laundry items in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a final spin cycle, basket 120 is rotated at relatively high speeds and drain pump assembly 144 may discharge wash fluid from sump 142. After articles disposed in wash basket 120 are cleaned, washed, and/or rinsed, the user can remove the articles from wash basket 120, e.g., by opening door 134 and reaching into wash basket 120 through chamber opening 132.

While described in the context of a specific embodiment of horizontal axis washing machine appliance 100, using the teachings disclosed herein it will be understood that horizontal axis washing machine appliance 100 is provided by way of example only. Other washing machine appliances having different configurations, different appearances, and/or different features may also be utilized with the present subject matter as well, e.g., vertical axis washing machine appliances.

Referring still to FIG. 1, a schematic diagram of an external communication system 170 will be described according to an exemplary embodiment of the present subject matter. In general, external communication system 170 is configured for permitting interaction, data transfer, and other communications between washing machine appliance 100 and one or more external devices. For example, this communication may be used to provide and receive operating parameters, user instructions or notifications, performance characteristics, user preferences, or any other suitable information for improved performance of washing machine appliance 100. In addition, it should be appreciated that external communication system 170 may be used to transfer data or other information to improve performance of one or more external devices or appliances and/or improve user interaction with such devices.

For example, external communication system 170 permits controller 166 of washing machine appliance 100 to communicate with a separate device external to washing machine appliance 100, referred to generally herein as an external device 172. As described in more detail below, these communications may be facilitated using a wired or wireless connection, such as via a network 174. In general, external device 172 may be any suitable device separate from washing machine appliance 100 that is configured to provide and/or receive communications, information, data, or commands from a user. In this regard, external device 172 may be, for example, a personal phone, a smartphone, a tablet, a laptop or personal computer, a wearable device, a smart home system, or another mobile or remote device.

In addition, a remote server 176 may be in communication with washing machine appliance 100 and/or external device 172 through network 174. In this regard, for example, remote server 176 may be a cloud-based server 176, and is thus located at a distant location, such as in a separate state, country, etc. According to an exemplary embodiment, external device 172 may communicate with a remote server 176 over network 174, such as the Internet, to transmit/receive data or information, provide user inputs, receive user notifications or instructions, interact with or control washing machine appliance 100, etc. In addition, external device 172 and remote server 176 may communicate with washing machine appliance 100 to communicate similar information.

In general, communication between washing machine appliance 100, external device 172, remote server 176, and/or other user devices or appliances may be carried using any type of wired or wireless connection and using any suitable type of communication network, non-limiting examples of which are provided below. For example, external device 172 may be in direct or indirect communication with washing machine appliance 100 through any suitable wired or wireless communication connections or interfaces, such as network 174. For example, network 174 may include one or more of a local area network (LAN), a wide area network (WAN), a personal area network (PAN), the Internet, a cellular network, any other suitable short-or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 170 is described herein according to an exemplary embodiment of the present subject matter. However, it should be appreciated that the exemplary functions and configurations of external communication system 170 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

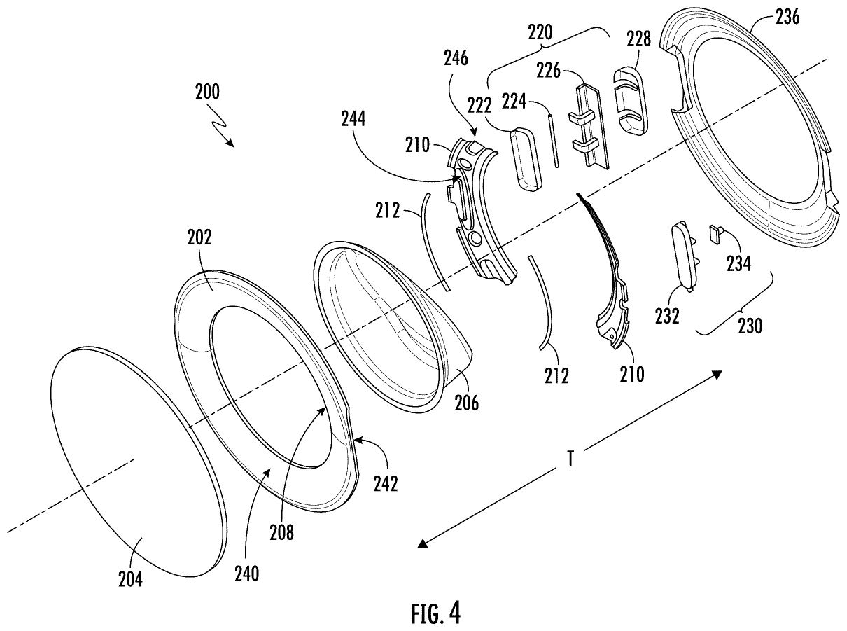

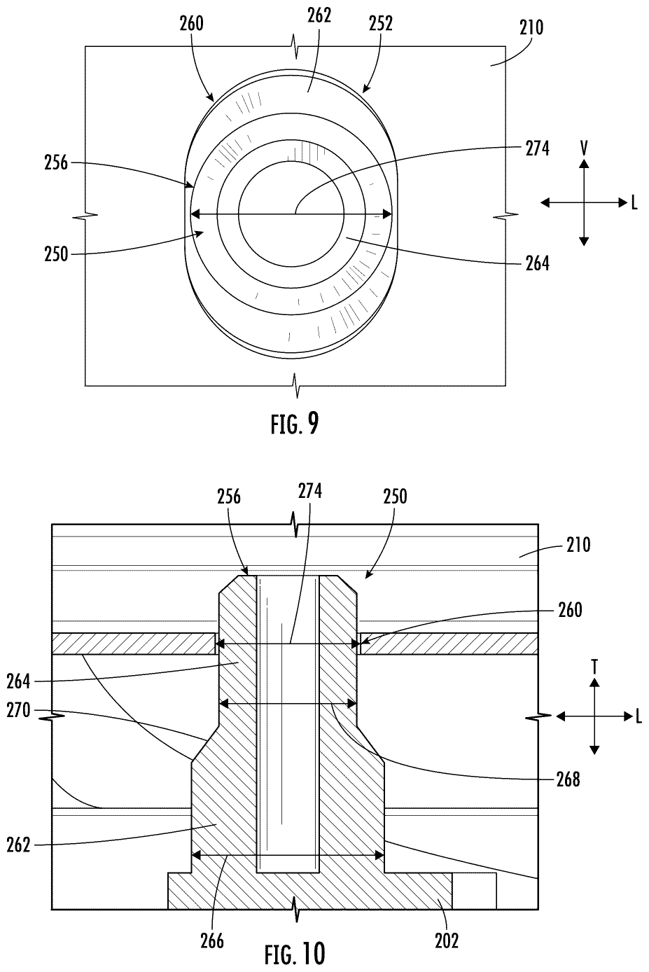

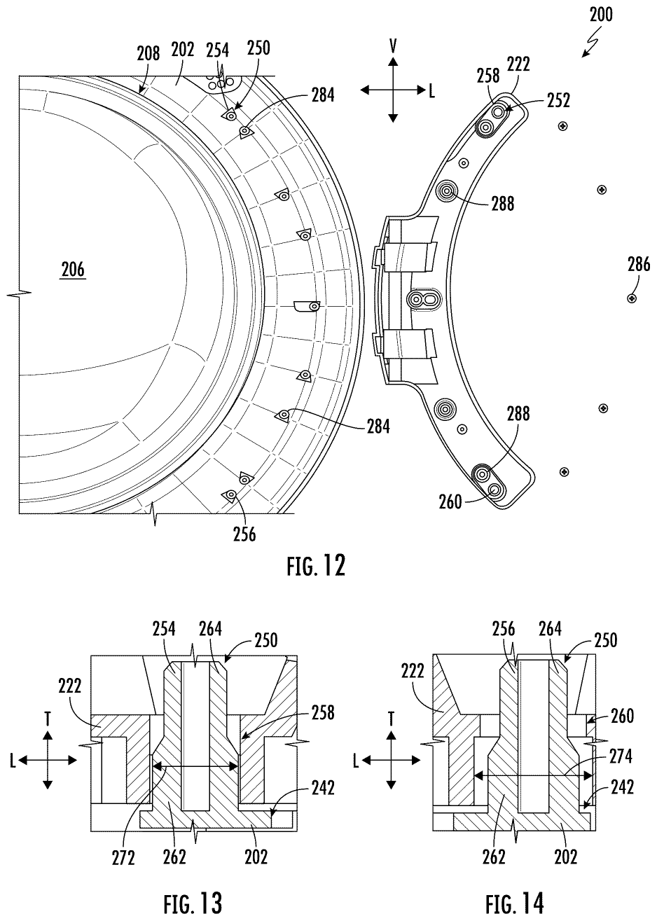

Referring now also generally to FIGS. 4 through 15, a door assembly 200 that may be used with washing machine appliance 100 will be described according to example embodiments of the present subject matter. In this regard, door assembly 200 may be the same as or replace door 134 as described above. In addition, although door assembly 200 is described herein as being used with washing machine appliance 100, it should be appreciated that door assembly 200 may be used on any other suitable laundry appliance, e.g., such as a dryer appliance, a combination washer/dryer appliance, or any other suitable appliance to provide selective access to an interior chamber through a front opening. Although an exemplary construction of door assembly 200 is described herein, it should be appreciated that variations and modifications may be made to the door assembly 200 while remaining within the scope of the present subject matter.

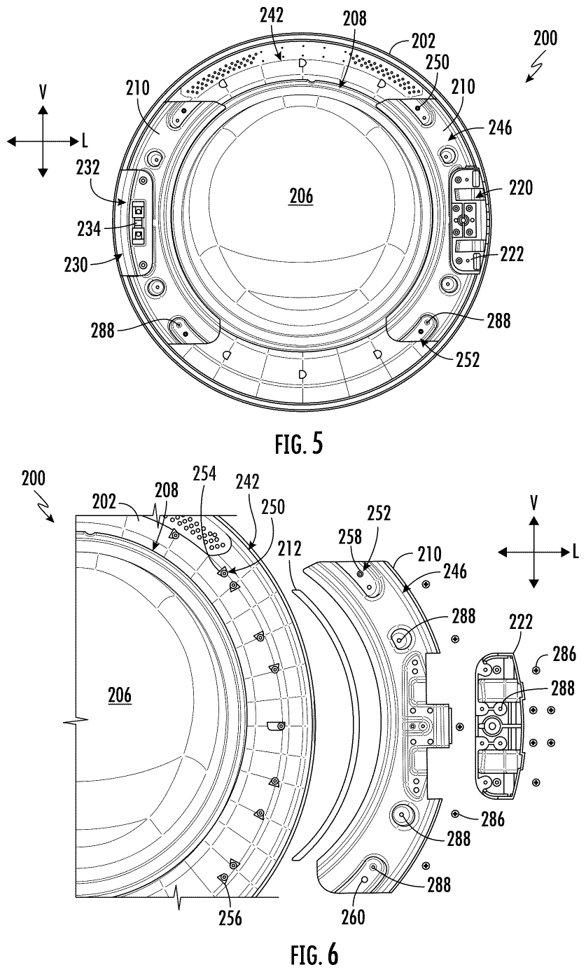

As shown in FIGS. 4 through 6, door assembly 200 will be described in more detail. In this regard, FIG. 4 provides a front, exploded view of door assembly 200, FIG. 5 provides a rear view of door assembly 200, and FIG. 6 provides a rear, exploded view of door assembly 200. As shown, the door assembly 200 may generally include various components that are stacked along the transverse direction T. It should be appreciated that the directional orientation used to describe door assembly 200 may be similar to that used to describe the washing machine appliance 100, assuming door assembly 200 is in the closed position. Door assembly 200 may include an outer door frame 202 on which to an outer window 204 may be seated to provide a front appearance piece and contact area for door assembly 200. In addition, a glass door bowl 206 may be seated within a central aperture 208 of outer door frame 202. As will be described in more detail below, one or more reinforcement brackets 210 may be mounted to or attached to outer door frame 202 to secure glass bowl 206 to door frame 202 and to provide structural support for other attachment features of door assembly 200. According to the illustrated embodiment, door assembly 200 may include two reinforcement brackets 210 and two isolator strips 212 that are positioned between reinforcement brackets 210 and glass bowl 206 to secure glass bowl 206 to outer door frame 202.

According to the illustrated embodiment, the door assembly 200 may further include a hinge assembly 220 that is designed to attach door assembly 200 to the front panel 130 of cabinet 102. Hinge assembly 220 may generally be designed to support one side of door assembly 200 and permit rotation about a vertical axis to facilitate selective access to wash chamber 126 through chamber opening 132. For example, according to the illustrated embodiment, hinge assembly 220 may generally include a hinge bracket 222 that is mounted to reinforcement bracket 210 as described in more detail below. A hinge pin 224 may rotatably couple hinge bracket 222 to a door hinge 226. In addition, a hinge bracket cover 228 may be positioned over hinge bracket 222 to prevent pinching and conceal working components of hinge assembly 220.

In addition, door assembly 200 may include a handle assembly 230 that a user may grasp to open and close door assembly 200. Handle assembly 230 may also be used to secure or lock door assembly 200 in the closed position. For example, handle assembly 230 may generally include a handle body 232 that attaches to reinforcement bracket 210 on an opposite lateral side of the door assembly 200 relative to hinge assembly 220. A striker 234 may be mounted within or attached to handle body 232 for engaging a latching or locking mechanism positioned within front panel 130 of cabinet 102. In addition, door assembly 200 may include an inner door panel 236 that mounts to outer door frame 202 and conceals various components of door assembly 200.

It should be appreciated that various components of door assembly 200 may be formed from any suitably rigid and durable material. For example, outer door frame 202, hinge bracket 222, handle body 232, and other components may be injection molded from any suitable plastic material. For example, according to exemplary embodiments, these components may be formed by injection molding, e.g., using a suitable plastic material, such as injection molding grade Polybutylene Terephthalate (PBT), Nylon 6, high impact polystyrene (HIPS), acrylonitrile butadiene styrene (ABS), polypropylene (PP), glass/talc filled polypropylene, or any other suitable blend of polymers. Alternatively, according to the exemplary embodiment, these components may be compression molded, e.g., using sheet molding compound (SMC) thermoset plastic or other thermoplastics. According to still other embodiments, portions of door assembly 200 may be formed from any other suitable rigid material. According to example embodiments, reinforcement brackets 210, hinge pin 224, and other components of door assembly 200 may be formed from metal, e.g., such as stamped, rolled, or otherwise formed sheet metal.

Notably, as described briefly above, conventional outer door frames do not include component locators that can receive a non-reversible door hinge bracket or reinforcement brackets for a reversible door hinge bracket, necessitating the use of outer door frames having different designs, tooling, costs, and decreased flexibility. Conventional door assemblies also experience issues with accounting for door sag for a washer or dryer, specifically related to the striker alignment of the door. There are multiple components of a laundry appliance door that contribute to striker alignment of the appliance door when it is opened and closed, including the reinforcement brackets. Improperly constraining the degrees of freedom of the reinforcement brackets with insufficient locating features and/or fasteners adds more variation to the assembly and the striker alignment, as well as making assembly more difficult.

Accordingly, aspects of the present subject matter are directed to a door assembly 200 with improved versatility, alignment features, reduced costs, improved attachment features, and simplified assembly. Although an exemplary construction is described herein, it should be appreciated that variations and modifications may be made while remaining within the scope of the present subject matter. In addition, it should be appreciated that although one configuration of door assembly 200 is described where the hinge assembly 220 is on the left and the handle assembly 230 is on the right, these components may be swapped or interchangeable for a reversible door.

According to the illustrated embodiment, outer door frame 202 may generally define a first face 240 and a second face 242 positioned opposite first face 240 along the transverse direction T. In this regard, first face 240 may be oriented outward relative to wash chamber 126, and second face 242 may be oriented toward wash chamber 126. Similarly, reinforcement bracket 210 may generally define a first face 244 and a second face 246 positioned opposite first face 244 along the transverse direction T. In this regard, first face 244 may oriented outward relative to wash chamber 126, e.g., toward second face 242 of outer door frame 202 such that it is seated thereon when door assembly 200 is assembled, and second face 246 may be oriented toward wash chamber 126.

Reinforcement bracket 210, when assembled, may be positioned on outer door frame 202, e.g., such that second face 242 of outer door frame 202 is facing or in contact with first face 244 of reinforcement bracket 210. Moreover, it should be appreciated that reinforcement bracket 210 may be reversible, i.e., it may be positioned in the same manner on both the left and right side of door assembly 200, as shown for example in FIG. 5. As will be explained in more detail below, outer door frame 202 and reinforcement bracket 210 may define a plurality of pins 250 and complementary apertures 252 that facilitate quick and accurate alignment and assembly of door assembly 200, which constrains all degrees of freedom of outer door frame 202 and reinforcement bracket 210. Although example configurations of pins 250 and apertures 252 are described below, it should be appreciated that these are only examples to facilitate discussion of the present subject matter. Pins 250 and apertures 252 may be swapped, their configurations may change, geometries may be adjusted, and other variations may be made while remaining within the scope of the present subject matter.

Referring now specifically to FIGS. 5 through 10, outer door frame 202 may define a first pin 254 and a second pin 256 extending from second face 242 of outer door frame 202. In addition, reinforcement bracket 210 may define a first aperture 258 and a second aperture 260 on first face 244 of reinforcement bracket 210, e.g., opposite from first pin 254 and second pin 256, respectively. In this regard, first aperture 258 is configured to receive first pin 254 and second aperture 260 is configured to receive second pin 256 to engage outer door frame 202 and reinforcement bracket 210 in a manner that restricts translation and rotation in six degrees of freedom while also enabling quick and easy alignment and assembly. Although first pin 254 and second pin 256 are described as extending from outer door frame 202 and first aperture 258 and second aperture 260 are described as being defined by reinforcement bracket, it should be appreciated that these components may be swapped, repositioned, or reconfigured while remaining within the scope of the present subject matter.

In this regard, for example, first pin 254 is illustrated as a cylindrical member protruding along the transverse direction T. More specifically, as illustrated, each of first locator pin 254 and second locator pin 256 (and other pins 250) define a first portion 262 having a first width 266 and a second portion 264 having a second width 268. As shown, second width 268 is smaller than first width 266 for reasons that will be described in more detail below. As shown, second portion 264 is positioned on top of or at a distal end of first portion 262, e.g., opposite outer door frame 202.

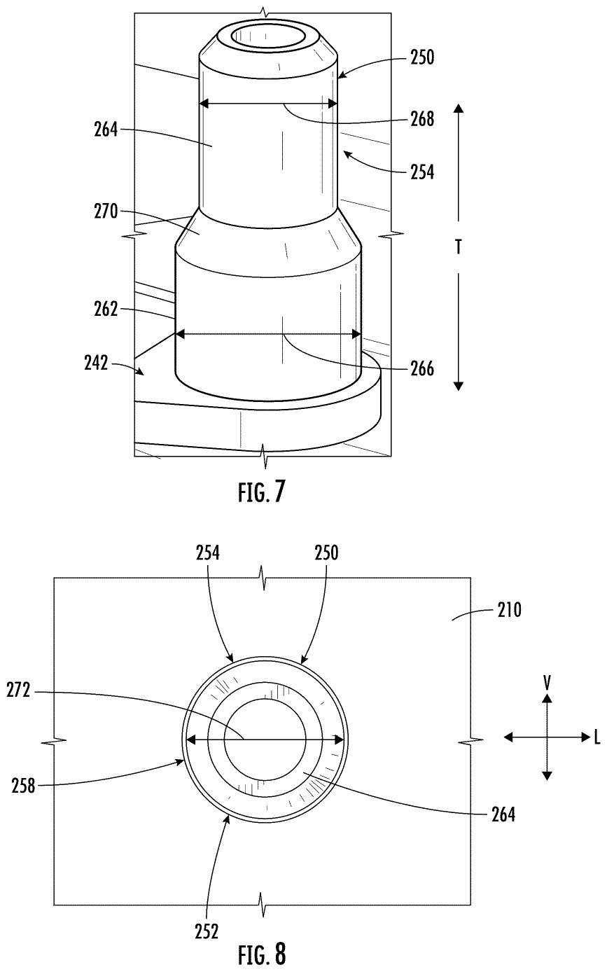

As best shown in FIGS. 7 and 10, first portion 262 and second portion 264 of first locator pin 254 and second locator pin 256 are joined by a tapered wall 270. In this manner, tapered wall 270 bridges the difference in width between first width 266 and second width 268, e.g., in a roughly linear tapered surface. In addition, a distal end of second portion 264 may also be tapered, which may facilitate simplified assembly of components. As will be explained in more detail below, this construction of locator pins 250 allows for multiple components (referred to herein generally as “brackets”) to be installed onto outer door frame 202 while constraining all degrees of freedom between these components.

In this regard, for example, when the bracket is reinforcement bracket 210, first aperture 258 and second aperture 260 may have a diameter that is substantially equal to second width 268 of second portion 264. In other words, a first aperture width 272 of first aperture 258 and a second aperture width 274 of second aperture 260 are equal to or form a tight clearance with second width 268 of first locator pin 254 and second locator pin 256. Therefore, reinforcement brackets 210 may be supported by locator pins 250 around their respective second portions 264, e.g., above tapered wall 270. These features may be symmetrical such that reinforcement bracket 210 may be installed in the same manner on either side of door assembly. Moreover specifically, first pin 254 and first aperture 258 may be designed with a tight tolerance such that inserting first pin 254 into first aperture 258 prevents relative movement between outer door frame 202 and reinforcement bracket 210 in four degrees of freedom. Specifically, first pin 254 and first aperture 258 may engage each other to restrict relative movement of outer door frame 202 and reinforcement bracket 210, preventing translation along the lateral direction L and the vertical direction V and rotation about the vertical direction V and the lateral direction L.

Notably, according to the illustrated embodiment, second aperture 260 is elongated along the vertical direction V. In this regard, the width of second aperture 260 may be the same as the diameter of second pin 256, but second aperture 260 may be oversized along the vertical direction V. In this manner, second pin 256 engages second aperture 260 to prevent relative movement between outer door frame 202 and reinforcement bracket 210 in two degrees of freedom. Specifically, second pin 256 and second aperture 260 may engage each other to restrict relative movement of outer door frame 202 and reinforcement bracket 210, preventing translation along the transverse direction T and rotation about the transverse direction T. In this manner, when outer door frame 202 and reinforcement bracket 210 are assembled such that first pin 254 and second pin 256 engage first aperture 258 and second aperture 260, respectively, these components are constrained in six degrees of freedom. Moreover, such a construction prevents door assembly 200 being over-constrained, which simplifies assembly.

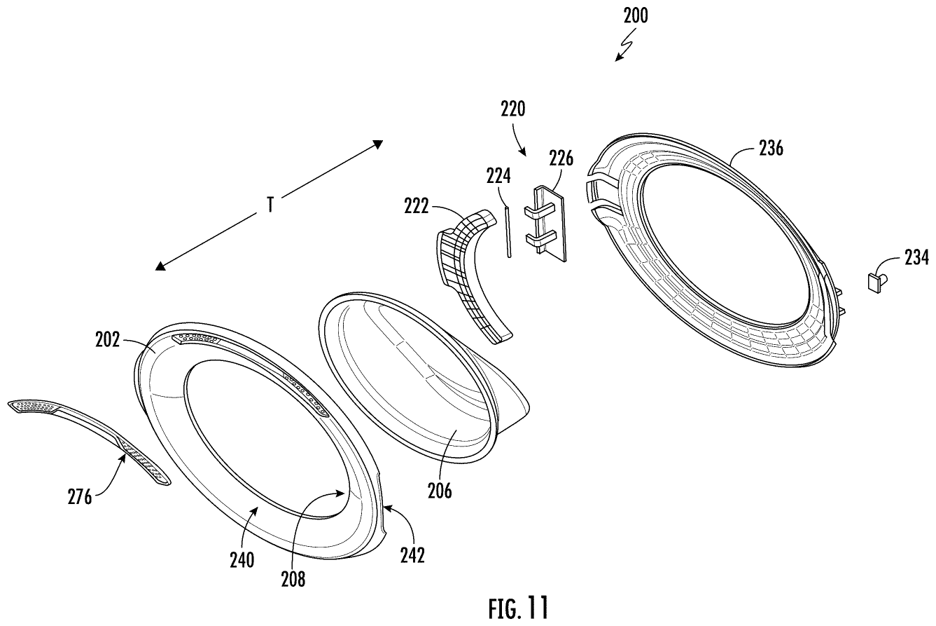

As explained above, outer door frame 202 may be designed such that it can receive multiple components, e.g., such as reversible reinforcement brackets 210 and hinge bracket 222, thus reducing the tooling, costs, and assembly time to manufacture door assembly 200. In this regard, referring now specifically to FIGS. 11 through 14, hinge bracket 222 will be described in more detail according to an example embodiment of the present subject matter. As shown, door assembly 200 may include a door vent 276 in place of or together with outer window 204. Notably, hinge bracket 222 may define apertures 252 that are similar to those in reinforcement bracket 210, and like numerals will be used to refer to the same or similar apertures 252 between reinforcement bracket 210 and hinge bracket 222.

In this regard, as illustrated, when the bracket attached to outer door frame 202 is a non-reversible door hinge bracket 222, first aperture 258 and second aperture 260 may have a diameter that is substantially equal to first width 266 of first portion 262. In other words, first aperture width 272 of first aperture 258 and a second aperture width 274 of second aperture 260 of door hinge bracket 222 are equal to or form a tight clearance with first width 266 of first locator pin 254 and second locator pin 256. Therefore, hinge bracket 222 may be supported by locator pin 250 around their respective first portions 262, e.g., below tapered wall 270. Moreover specifically, first pin 254 and first aperture 258 may be designed with a tight tolerance such that inserting first pin 254 into first aperture 258 prevents relative movement between outer door frame 202 and hinge bracket 222 in four degrees of freedom. Specifically, first pin 254 and first aperture 258 may engage each other to restrict relative movement of outer door frame 202 and hinge bracket 222, preventing translation along the lateral direction L and the vertical direction V and rotation about the vertical direction V and the lateral direction L.

Similar to second aperture 260 of reinforcement bracket 210, second aperture 260 of hinge bracket 222 may be elongated along the vertical direction V. In this regard, the width of second aperture 260 may be the same as the diameter of second pin 256, but second aperture 260 may be oversized along the vertical direction V. In this manner, second pin 256 engages second aperture 260 to prevent relative movement between outer door frame 202 and hinge bracket 222 in two degrees of freedom. Specifically, second pin 256 and second aperture 260 may engage each other to restrict relative movement of outer door frame 202 and hinge bracket 222, preventing translation along the transverse direction T and rotation about the transverse direction T. In this manner, when outer door frame 202 and hinge bracket 222 are assembled such that first pin 254 and second pin 256 engage first aperture 258 and second aperture 260, respectively, these components are constrained in six degrees of freedom. Moreover, such a construction prevents door assembly 200 being over-constrained, which simplifies assembly.

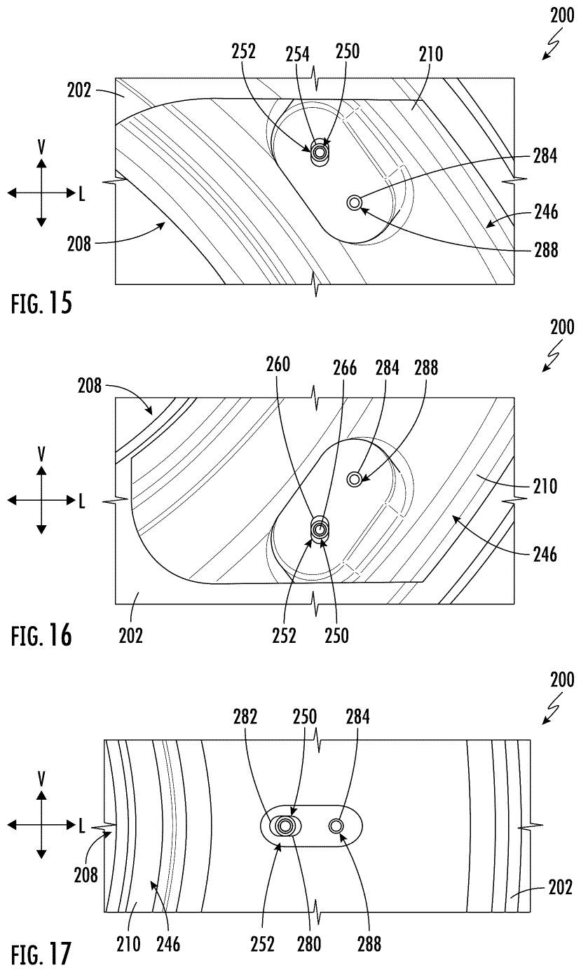

According to another example embodiment, more than one aperture 252 may be elongated along the lateral direction L or the vertical direction V. For example, referring now to FIGS. 15 through 17, first aperture 258 and second aperture 260 are elongated along the vertical direction V. In addition, a third pin 280 extends from second face 242 of outer door frame 202 and a third aperture 282 is defined on hinge bracket 222 opposite from third pin 280. As illustrated, third aperture 282 is elongated along lateral direction L and is configured to receive third pin 280. In this manner, first pin 254, second pin 256, and third pin 280 engage first aperture 258, second aperture 260, and third aperture 282, respectively, to prevent relative movement between hinge bracket 222 and outer door frame 202 in six degrees of freedom. Similarly, a third aperture 282 is defined on reinforcement bracket 210 opposite from third pin 280. As illustrated, third aperture 282 is elongated along lateral direction L and is configured to receive third pin 280. In this manner, first pin 254, second pin 256, and third pin 280 engage first aperture 258, second aperture 260, and third aperture 282, respectively, to prevent relative movement between reinforcement bracket 210 and outer door frame 202 in six degrees of freedom.

Door assembly 200 may further include a series of through holes and bosses that receive fasteners to complete assembly. For example, as illustrated, outer door frame 202 may define a plurality of screw bosses 284 that are configured to receive a mechanical fastener 286, e.g., such as a mechanical screw. In addition, reinforcement bracket 210 and hinge bracket 222 may define one or more through holes 288 that mechanical fasteners 286 may pass through before engaging screw bosses 284. In this regard, by passing mechanical fasteners 286 through reinforcement bracket 210 and into screw bosses 284 defined on outer door frame 202, reinforcement bracket 210 and outer door frame 202 may be properly joined. Similarly, by passing mechanical fasteners 286 through hinge bracket 222 and into screw bosses 284 defined on outer door frame 202, hinge bracket 222 and outer door frame 202 may be properly joined. Thus, once mechanical fasteners 286 are installed, relative motion between these components may be restrained in all degrees of freedom.

According to the illustrated embodiment, pins 250 may be used only for alignment and separate through holes 288 and screw bosses 284 may be defined elsewhere on hinge bracket 222 and reinforcement bracket 210. However, it should be appreciated that according to alternative embodiments, pins 250 may define screw bosses 284 for receipt of mechanical fasteners 286. Other configurations and attachment mechanisms between outer door frame 202, reinforcement bracket 210, and hinge bracket 222 may be used while remaining within the scope of the present subject matter.

In addition, although pins 250 are illustrated above as being cylindrical pins with two portions having different widths, it should be appreciated that pins 250 may alternatively refer to any protrusion or feature having any suitable size, geometry, or configuration, such as tabs, cones, or any other suitable protruding locating features. For example, pins 250 may be rectangular protrusions and apertures 252 may also be rectangular. Apertures 252 may be oversized in at least one direction such that receipt of pins 250 constrains translation in one direction but not the other. According to still other embodiments, pins 250 may be cylindrical and apertures 252 may be a rectangle (e.g., instead of an elongated circle). Other pin/aperture configurations are possible and within the scope of the present subject matter.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A laundry appliance defining a vertical direction, a lateral direction, and a transverse direction, the laundry appliance comprising:
a tub positioned within a cabinet;
a basket rotatably mounted within the tub and defining a chamber for receiving of a load of clothes; and
a door assembly rotatably mounted to the cabinet to provide selective access to the chamber, the door assembly comprising:
an outer door frame defining a first face and a second face positioned opposite the first face along the transverse direction;
a first locator pin and a second locator pin extending from the second face of the outer door frame, wherein each of the first locator pin and the second locator pin define a first portion having a first width and a second portion having a second width smaller than the first width, the second portion being positioned on top of the first portion opposite the outer door frame;
a bracket defining a first face and a second face positioned opposite the first face along the transverse direction, the bracket being mounted to the second face of the outer door frame; and
a first aperture and a second aperture defined on the first face of the bracket opposite from the first locator pin and the second locator pin, wherein the first aperture is configured to receive the first locator pin and the second aperture is elongated along the vertical direction and configured to receive the second locator pin.

2. The laundry appliance of claim 1, wherein the first locator pin engages the first aperture to prevent relative movement between the outer door frame and the bracket in four degrees of freedom.

3. The laundry appliance of claim 2, wherein the four degrees of freedom are translation along the lateral direction and the vertical direction and rotation about the vertical direction and the lateral direction.

4. The laundry appliance of claim 1, wherein the second locator pin engages the second aperture to prevent relative movement between the outer door frame and the bracket cover in two degrees of freedom.

5. The laundry appliance of claim 4, wherein the two degrees of freedom are translation along the transverse direction and rotation about the transverse direction.

6. The laundry appliance of claim 1, wherein the first portion and the second portion of the first locator pin and the second locator pin are joined by a tapered wall.

7. The laundry appliance of claim 1, wherein the bracket is a non-reversible door hinge bracket, the first aperture has a first aperture width equal to or forming a tight clearance with the first width of the first locator pin, and the second aperture has a second aperture width equal to or forming a tight clearance with the first width of the second locator pin.

8. The laundry appliance of claim 1, wherein the bracket is a reversible door reinforcement bracket, the first aperture has a first aperture width equal to or forming a tight clearance with the second width of the first locator pin, and the second aperture has a second aperture width equal to or forming a tight clearance with the second width of the second locator pin.

9. The laundry appliance of claim 1, wherein the first aperture is elongated along the vertical direction and the door assembly further comprises:
a third locator pin extending from the second face of the outer door frame; and
a third aperture defined on the first face of the bracket opposite from the third locator pin, wherein the third aperture is elongated along the lateral direction and is configured to receive the third locator pin.

10. The laundry appliance of claim 9, wherein the first locator pin engages the first aperture, the second locator pin engages the second aperture, and the third locator pin engages the third aperture to prevent relative movement between the outer door frame and the bracket in six degrees of freedom.

11. The laundry appliance of claim 1, wherein at least one of the first locator pin or the second locator pin is cylindrical and at least one of the first aperture or the second aperture is an elongated circle or a rectangle.

12. The laundry appliance of claim 1, wherein at least one of the first locator pin or the second locator pin is rectangular and at least one of the first aperture or the second aperture is a rectangle.

13. The laundry appliance of claim 1, wherein the outer door frame defines a screw boss and the bracket defines a through hole, the door assembly further comprising:
a mechanical fastener that is inserted through the through hole of the bracket and into the screw boss of the outer door frame to prevent relative movement between the outer door frame and the bracket cover along the transverse direction.

14. The laundry appliance of claim 1, wherein the first locator pin and the second locator pin extend along the transverse direction.

15. The laundry appliance of claim 1, wherein the laundry appliance is a front load washing machine appliance or a front load dryer appliance.

16. A door assembly for a laundry appliance, the laundry appliance defining a vertical direction, a lateral direction, and a transverse direction, the laundry appliance comprising a tub positioned within a cabinet and a basket rotatably mounted within the tub and defining a chamber for receiving of a load of clothes, the door assembly comprising:
an outer door frame defining a first face and a second face positioned opposite the first face along the transverse direction;
a first locator pin and a second locator pin extending from the second face of the outer door frame, wherein each of the first locator pin and the second locator pin define a first portion having a first width and a second portion having a second width smaller than the first width, the second portion being positioned on top of the first portion opposite the outer door frame;
a bracket defining a first face and a second face positioned opposite the first face along the transverse direction, the bracket being mounted to the second face of the outer door frame; and
a first aperture and a second aperture defined on the first face of the bracket opposite from the first locator pin and the second locator pin, wherein the first aperture is configured to receive the first locator pin and the second aperture is elongated along the vertical direction and configured to receive the second locator pin.

17. The door assembly of claim 16, wherein the bracket is a non-reversible door hinge bracket, the first aperture has a first aperture width equal to or forming a tight clearance with the first width of the first locator pin, and the second aperture has a second aperture width equal to or forming a tight clearance with the first width of the second locator pin.

18. The door assembly of claim 16, wherein the bracket is a reversible door reinforcement bracket, the first aperture has a first aperture width equal to or forming a tight clearance with the second width of the first locator pin, and the second aperture has a second aperture width equal to or forming a tight clearance with the second width of the second locator pin.

19. The door assembly of claim 16, wherein the first aperture is elongated along the vertical direction and the door assembly further comprises:
a third locator pin extending from the second face of the outer door frame; and
a third aperture defined on the first face of the bracket opposite from the third locator pin, wherein the third aperture is elongated along the lateral direction and is configured to receive the third locator pin.

20. The door assembly of claim 16, wherein at least one of the first locator pin or the second locator pin is cylindrical and at least one of the first aperture or the second aperture is an elongated circle or a rectangle, or wherein at least one of the first locator pin or the second locator pin is rectangular and at least one of the first aperture or the second aperture is a rectangle.
